(19) United States
(12) Patent Application Publication
(10) Pub. No.: US 2015/0178425 A1
(43) Pub. Date: Jun. 25, 2015

(54) METHOD FOR MODELING GRAPHICS ON A FLEXIBLE FORM

(71) Applicant: The Procter & Gamble Company, Cincinnati, OH (US)

(72) Inventors: Xiahua Zheng, Cincinnati, OH (US); Michael Timothy Looney, Blue Ash, OH (US); Michael Lewis Rubin, Mason, OH (US); Nicholle Yoshikawa Rauch, Cincinnati, OH (US)

(21) Appl. No.: 14/577,341

(22) Filed: Dec. 19, 2014

Related U.S. Application Data
(60) Provisional application No. 61/919,238, filed on Dec. 20, 2013.

(51) Int. Cl. G06F 17/50

(52) U.S. Cl. CPC G06F 17/5018

(57) ABSTRACT

A method for modeling a flexible form that includes creating a computer based predictive simulation of a flexible form surface with graphics comprised of a mesh made of one or more nodes is disclosed. The method is used in the creation of flexible forms.

### FIELD OF THE INVENTION

In general, the present disclosure relates to computer based models for simulating graphics on a flexible form. The model is then used to improve upon the printed flexible form. In particular, the present disclosure relates to computer based models for simulating graphics on a stretchable and flexible form including package. In particular, the present disclosure relates to methods of modeling the graphics based on the materials used for the package and the goods inside a package to create a virtual model allowing simultaneous and interactive design of product, flexible package and graphics.

### BACKGROUND OF THE INVENTION

It has been a common practice to visualize and analyze rigid forms assuming flat surfaces such as boxes using well developed tools to do so from initial package design to package appearance. However, flexible forms present a unique challenge. For example, flexible packages present unique challenges in creating 3D package models for analysis and visualization. The shape and appearance of flexible packages is defined by the product inside versus the package itself. In addition to package material and geometry, flexible package models need to characterize compressible and non-uniform product inside the packages, which can shift and deform resulting in wrinkles and deformations in the package material. The simulation of light interacting with product must also handle how color, textures, light and artwork layout would change depending on wrinkles and deformation of these flexible packages.

As a result, it would be beneficial to develop a method that allows one to simulate the appearance of a flexible form such as a flexible package containing products. Specifically, it would be beneficial to simulate the graphics on a flexible package containing products while being able to handle how color, textures, light and artwork layout would change depending on wrinkles and deformations of the flexible package. This model can then be used to create an improved flexible form for a given product to have the desired image on the flexible form. The flexible form may be a package. It would also be beneficial to be able to manipulate the model while showing how the manipulations impact the visual graphics.

### SUMMARY OF THE INVENTION

The present invention relates to a method for modeling a flexible form. The method comprises creating a computer based predictive simulation of a flexible form comprised of a mesh made of one or more nodes wherein the flexible form has a surface. The method further includes simulating a deformation of the flexible form wherein the deformation is based on the interaction with a defined force and the flexible form material properties, and coupling the simulation output data to the optical properties of the flexible form by correlating simulation output data to optical properties and using a surface coordinate system to map the correlated optical properties at each location on the flexible form. Mapping the correlated optical properties at each location to a three dimensional form includes mapping the graphics and color position of graphic images to the flexible form wherein the color or graphic overlay utilizes the simulated position of nodes in the mesh to create a predictive simulation appearance model. The model may further include rendering one or more frames of the predictive simulation appearance model using light transport physics. Once complete, the model may be used to create the printed flexible form including the graphics.

The present invention further relates to a system for modeling a package, comprising: a memory component that stores logic that when executed by the system causes the system to perform at least the following: create a computer based predictive simulation of a flexible form comprised of a mesh made of one or more nodes wherein the flexible form has a surface; simulate a deformation of the flexible form wherein the deformation is based on the interaction with a defined force and the flexible form material properties; couple the graphics to the flexible form by using a surface coordinate system; couple the simulation output data to the optical properties of the flexible form; and map correlated optical properties at each location on the flexible form to a three dimensional form. A color or graphic overlay utilizes the simulated position of nodes in the mesh to create a predictive simulation appearance model. In an embodiment, the flexible form is a package comprising a domain space. In an embodiment, simulating a deformation of the flexible form includes simulating the addition of goods into the domain space of the package wherein the goods within the domain space deform the outer surface of the package. In an embodiment the memory component processes a final rendering using physics based software to simulate light transport and generate a photo-real image of the package.

The present invention still further relates to a non-transitory computer-readable medium for modeling a package that stores a computer program that when executed by a computing device, causes the computing device to perform at least the following: create a computer based predictive simulation of a flexible form comprised of a mesh made of one or more nodes wherein the flexible form has a surface; simulate a deformation of the flexible form wherein the deformation is based on the interaction with a defined force and the flexible form material properties; couple the graphics to the flexible form by using a surface coordinate system; couple the simulation output data to the optical properties of the flexible form; and map correlated optical properties at each location on the flexible form to a three dimensional form. The color or graphic overlay utilizes the simulated position of nodes in the mesh to create a predictive simulation appearance model. In an embodiment, the flexible form is a package comprising a domain space. In an embodiment, simulating a deformation of the flexible form includes simulating the addition of goods into the domain space of the package wherein the goods within the domain space deform the outer surface of the package. In an embodiment the memory component processes a final rendering using physics based software to simulate light transport and generate a photo-real image of the package.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 is a chart illustrating a method for modeling the graphics on a package.

FIG. 2 is a chart illustrating a computer system.

FIGS. 3A-K are perspective views of different potential packages.

FIGS. 4A-C are perspective views of a flexible form with graphics across multiple frames.

FIG. 5 is a perspective view of a package.

FIG. 6 is a perspective view of a packages without graphics.

FIGS. 7A-C are perspective views of a package with graphics.

FIG. 8 is a view of multiple packages on a shelf.

### DETAILED DESCRIPTION

As used herein, “absorbent article” refers to a device or implement that has the capacity to uptake and to release a fluid. An absorbent article can receive, contain, and absorb bodily exudates (e.g. urine, menses, feces, etc.). Absorbent articles include absorbent articles placed inside the body, in particular tampons and the like. Other non-limiting examples of absorbent articles include absorbent articles worn next to the human body, in particular sanitary napkins, panti-liners, interlabial pads, diapers, pull-on diapers, training pants, incontinence products, toilet tissue, paper towels, facial tissue, wound dressings, and the like.

As used herein, “boundary conditions” are defined variables that represent physical factors acting within a computer based model. Examples of boundary conditions include forces, pressures, velocities, and other physical factors. Each boundary condition may be assigned a particular magnitude, direction, and location within the model. These values may be determined by observing, measuring, analyzing, and estimating real world physical factors. Computer based models may also include one or more boundary conditions that differ from real world physical factors to account for inherent limitations in the models and to more accurately represent the overall physical behaviors of real world things, as will be understood by one of ordinary skill in the art. Boundary conditions may act on the model in various ways, to move, constrain, and deform one or more parts in the model.

As used herein, “good” or “goods” relates to any commercial items that may be transported on a pallet. Goods are tangible, movable, and generally not consumed at the same time they are produced. Goods include, without limitation, appliances, auto parts, beverages including alcoholic beverages and non-alcoholic beverages, business equipment, cigarettes, confectioners, dairy products, electronic equipment, farm products, food, home furnishings and fixtures, housewares and accessories, meat products, office supplies, packaging and containers, laundry detergent, paper and paper products, personal products, photographic equipment and supplies, processed and packaged goods, recreational goods, rubber and plastics, sporting goods, textiles (clothing, footwear, and accessories), and toys.

As used herein a “flexible form” relates to a material that may sustain a strain of at least 10% in at least one direction without breaking, rupturing or tearing such that the item remains intact. The flexible form may be a single sheet or in the form of a package. In an embodiment, the flexible form may be in the form of a hollow package with one or more openings. Examples of flexible forms include and are not limited to, an absorbent article, a plastic bag, a sheet of paper, a nonwoven, a cloth, or combinations thereof.

As used herein, a “package” relates to a container in which a good is packed for purchase, storage, or transportation. Values disclosed herein as ends of ranges are not to be understood as being strictly limited to the exact numerical values recited. Instead, unless otherwise specified, each numerical range is intended to mean both the recited values and any integers within the range. For example, a range disclosed as “1 to 10” is intended to mean “1, 2, 3, 4, 5, 6, 7, 8, 9, and 10.”

As used herein, a “predictive simulation” relates to a computational simulation related to an item that may flow over time wherein the method utilizes nodes, particles, or a parameterized surface that may be tracked within a material. Materials may include a fluid or a solid. Predictive simulation utilizes physics based properties including quantifiable physical quantities related to the material that may be measured in a real world scenario. Quantifiable physical quantities include but are not limited to, for example, modulus and density. A predictive simulation requires outputs beyond position that affect the material such as, for example, stress, strain, and temperature. An example of a “predictive simulation” is Finite Element Analysis (FEA).

As used herein, “transitive mapping software” refers to software that allows for one-to-one correspondence of the artwork pixels across all the geometry frames, including the final one. Transitive mapping software allows for the use of a “blend shape” allowing artwork mapped to the final geometry to exhibit physically correct displacement and strain.

Embodiments disclosed herein include methods of simulating a flexible form such as a package to determine how graphics applied to the flexible form appear when the flexible form interacts with a force, a material, or a body. In an embodiment, the method simulates how a package will appear once the package is filled with the corresponding good(s). The package may comprise a domain space that may comprise one or more goods and a fluid in the form of air or liquid. The package may have graphics on the exterior, the interior, or may have an outer wrapping comprising graphics. The present disclosure assists in predicting the visual aspect of the graphics on the exterior or on the interior of the package based on the type of package, the properties of the package material, and the goods inside the package. The model simulates the deformation and interaction of both packing materials and the products inside. As a result, packages comprising goods may be modeled to determine the visual aspect of the graphics and desired graphics may be matched to an appropriate package material for a set type and quantity of good(s).

Also included is a computing device that includes a memory component that stores logic that causes the system to receive a computer based simulation of a flexible form having a surface. The logic simulates a deformation of the flexible form wherein the deformation is based on the interaction with another body, material, or force and the flexible form material properties and coupling graphics and color position of graphic images to the flexible form wherein the color or graphic overlay utilizes the simulated position of nodes in the mesh to create a simulated appearance model. The logic further renders one or more frames of the simulated appearance model using light transport physics. The logic further assigns visual material properties and process a final rendering using physics based software to simulate light transport and generate a photo-real image of the package.

Also included is a non-transitory computer-readable medium that stores a program that when executed by a computing device causes the computing device to receive a computer based simulation of flexible form such as a package that comprises domain space and a packing material having a surface. The system then simulates the addition of goods into the domain space of the package wherein the goods within the domain space deform the surface of the package; extracting one or more frames of finite element analysis to graphics rendering software and establishing mapping between the artwork and the geometry. The system further assigns visual material properties and process a final rendering using physics based software to simulate light transport and generate a photo-real image of the package.

Computer aided engineering (CAE) is a broad area of applied science in which technologists use software to develop computer based models that represent real world things. The models can be transformed to provide information about the physical behavior of those real world things, under certain conditions and over particular periods of time. With CAE, the interactions of the computer based models are referred to as simulations. Sometimes the real world things are referred to as a problem and the computer based model is referred to as a solution.

Commercially available software can be used to conduct CAE. ABAQUS, LS-DYNA™, Fluent, from ANSYS™, Inc. in Canonsburg, Pa., Flow3D™, from Flow Science, Inc. in Santa Fe, N. Mex., and FeFlow™ from DHI-WASY in Berlin, Germany are examples of commercially available CAE software. ABAQUS™, LS DYNA™, ANSYS™, and MARC™ are examples of commercially available Structural Analysis software. The Structural Analysis software may utilize finite element analysis (FEA). In FEA, models representing mechanical articles, as well as their features, components, structures, and/or materials are transformed to predict stress, strain, displacement, deformation, and other mechanical behaviors. FEA represents a continuous solid material as a set of discrete elements. In FEA, the mechanical behavior of each element is calculated, using equations that describe mechanical behavior. The results of all of the elements are summed up to represent the mechanical behavior of the material as a whole.

Alternatively, CAE software or any derivative such as FEA software can be written as custom software or may be open source code software. FEA and CAE software can be run on various computer hardware, such as, for example, a personal computer, a minicomputer, a cluster of computers, a mainframe, a supercomputer, or any other kind of machine on which program instructions can execute to perform functions.

Graphic rendering relates to the addition of graphics to an image or data structure. The image or data structure may include geometry, viewpoint, texture, lighting, and shading information as a description of the virtual scene. Commercially available graphic rendering tools may be used to simulate the graphics on a package. Such tools include, for example, Maxwell®, Mental Ray® and Vray®.

CAE models utilizing graphic rendering tools can represent a number of real world things, such as the graphics on a flexible package stretched by the goods within the domain space of the package.

CAE in conjunction with graphic rendering tools can be used to design, simulate, and/or evaluate all kinds of packages, their features, materials, structures, and extensibility, as well as their appearance with graphics.

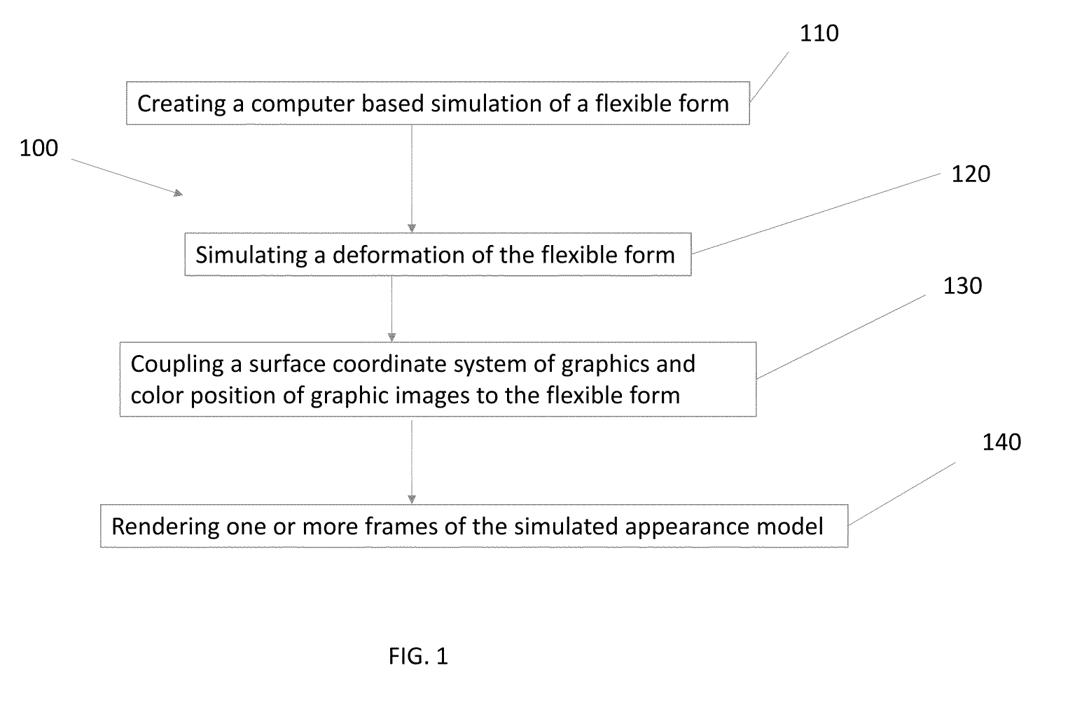

Referring now to the drawings, FIG. 1 shows a simplified flowchart of one embodiment of the present invention for generating and rendering a 3-D model of a flexible packaging.

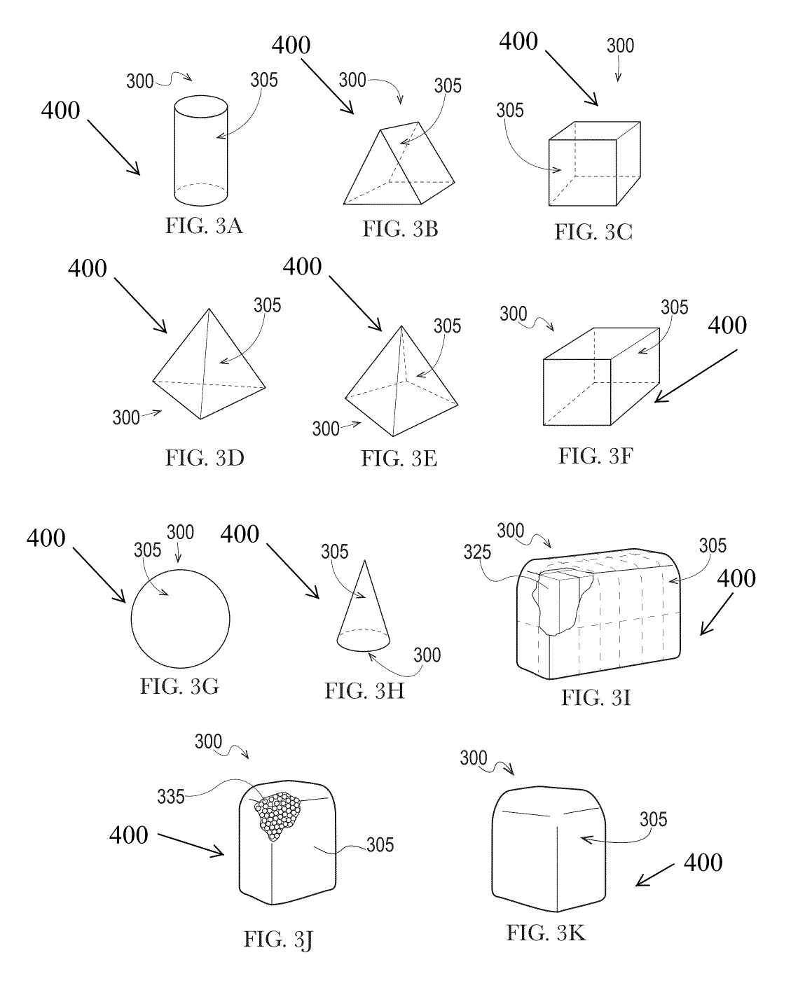

The method includes creating a computer based simulation of a flexible form comprised of a mesh made of one or more nodes wherein the flexible form has a surface 110. The flexible form may be a sheet or a package. The flexible form may bend upon itself without breaking. The flexible form may be in the form of a package. The package may comprise any shape including those geometry examples shown in FIGS. 3A-H. The package is made of a flexible material. The package material may be stretchable. The package material may comprise of more than one layer. The computer based model may be a mesh of the package. The computer based model may comprise nodes. The nodes may be used to create a one-to-one correspondence between nodes in the initial state and nodes in the final simulation.

The method further includes simulating a deformation of the flexible form wherein the deformation is based on the interaction with a defined force and the flexible form material properties 120. The defined force may be interactions with another body or material.

In an embodiment, simulating a deformation of the flexible form may represent forces upon a flexible sheet. The forces may impact the surface such that the surface may exhibit, for example, stretch points, wrinkles, bends, and other forms of deformations.

In an embodiment, simulating a deformation of the flexible form may be done by loading a package. The package may be loaded by expanding the package domain space to its full capacity and then inserting the goods within the domain space. The goods may be volumetrically compressed. Once the goods are inside the domain space, the package material may be allowed to contract onto the goods. In an embodiment, the goods are allowed to expand and are no longer compressed while the package material is simultaneously contracted to contact the goods within the domain space. The goods may be in the form of finished products, such as, for example, diapers. In an embodiment, the package may be a diaper deformed by either a fluid, a solid material, a semisolid material, or the wearer of the diaper. The goods may be deformable or non-deformable. Alternatively, loading the package may be done by adding each good to the virtual package such that the package is continuously deformed while the domain space is filled with the one or more goods.

In an embodiment, loading the package includes simulating deformation of the packing material starting from flat geometry to loaded package using finite element analysis. The simulation may include mapping one or more of the finite element outputs.

The method further includes coupling a surface coordinate system of graphics and color position of graphic images to the flexible form wherein the color or graphic overlay utilizes the simulated position of nodes in the mesh to create a simulated appearance model 130. Coupling the graphics includes coupling the simulation output data to the optical properties of the flexible form and mapping correlated optical properties at each location on the flexible form onto the flexible form. Coupling a surface coordinate system includes following the deformation of the packing material by exporting the simulation results to a graphic rendering software. Coupling one or more graphics and color position to the flexible form may include mapping a first plane to a second plane, wherein the first and second planes are tied together at one location. The first and second planes may be in close proximity to each other in a second location.

The method further includes rendering one or more frames of the simulated appearance model using light transport physics 140.

The method may further manipulate the model to determine the effect of different shapes, positions, inputs, and options. The package may deform further from change of boundary conditions such as internal and external forces. Internal and external forces may include, for example, the weight from a second package on the package, the force caused by a stretch wrap on the package, a pressure inside the package, an increasing pressure inside the package, a contracting pressure inside the package and combinations thereof.

In an embodiment the method may be used to determine the perception of the package by a user to qualify what the user considers an acceptable appearance. In an embodiment, the user does not control the model. The model may continue deforming the package based on predetermined parameters until the consumer states that the package is no longer acceptable. Determining the perception of the package by a user may be done at a computer storing the method or through a connection allowing the method to be stored on a server and accessed by the user. In an embodiment, the user initiates the method creating the predictive simulation of the flexible form. The user then gives input to the method determining if the appearance is acceptable. When deemed acceptable, the method may further deform the package and request input from the user. The process may repeat until the user deems the appearance unacceptable. The method may be repeated with a plurality of users to determine an acceptable range of appearance for the package.

The simulated package with graphics can be used in virtual consumer tests to evaluate consumer acceptance of deformed bag appearances. The information may be used to for package design criteria such as bag compression level, bag film caliper, pallet pattern/height.

If the output is not as desired by the user, one embodiment of the method provides a user interface for the user to interact with the model and enter information to change the parameters used in step 110, step 120, or step 130 and repeat the process.

The method includes a first step of creating a computer based simulation of a flexible form comprised of a mesh made of one or more nodes wherein the flexible form 300 has a surface 110. The flexible form 300 may be a package. FIG. 3 shows different embodiments of potential packages. The package 400 may vary in any dimension, such as, for example, height, length, and width. The package 400 may be of any suitable shape such as, for example, a square, a rectangle, a pyramid, or a cylinder. The package 400 may be an irregular shape, such as, for example, FIGS. 3I-K. The package 400 comprises a domain space 305. The package 400 may comprise a combination of the shapes shown in FIG. 3A-H, such as, for example a cone connected to a portion of a sphere. It shall be understood by one of ordinary skill in the art that a domain space 305 may be calculated by adding the domain space 305 of the portions or whole shapes that are added together to make a new shape for the package 400.

The package is made of a flexible material. The package material may be stretchable. The package material may comprise of more than one layer. In an embodiment, the user may enter parameters related to the package material and the package material properties such as, for example, flexibility, stretchability or extensibility, elastic modulus, bending stiffness, plasticity and material thickness.

The computer based model may be created as described below, with general references to a computer based model of the packages. A computer based model that represents the packages may be created by providing dimensions and material properties to the modeling software and by generating a mesh for the packages using meshing software. A mesh is a collection of small, connected polygon shapes that defines the set of discrete elements in a CAE computer based model. It is understood that he shapes may be two-dimensional, three-dimensional, or a combination of both. The type of mesh and/or the size of elements may be controlled with user inputs into the meshing software, as will be understood by one of ordinary skill in the art.

A computer based model of the packages may be created with dimensions that are similar to, or the same as, dimensions that represent parts of a real world primary package and a real world secondary package. These dimensions may be determined by measuring actual samples, by using known values, or by estimating values. Alternatively, a model of a package may be configured with dimensions that do not represent a real world package. For example, a model of a package may represent a new variation of a real world package or may represent an entirely new package. In these examples, dimensions for the model may be determined by varying actual or known values, by estimating values, or by generating new values. The model may be created by putting values for the dimensions of parts of the package into the modeling software.

The computer based model of the packages may be created with material properties that are similar to, or the same as, material properties that represent a real world package. These material properties may be determined by measuring actual samples, by using known values, or by estimating values. Alternatively, a model of a package may be configured with material properties that do not represent a real world package. For example, a model of a package may represent a new variation of a real world package or may represent an entirely new package. In these examples, material properties for the model may be determined by varying actual or known values, by estimating values, or by generating new values. The computer based model of the package may be created with more than one type of a virtual good.

The computer based model of the flexible form may be created with a mesh for the surface of the flexible form. In an embodiment, an external surface of a primary package or a secondary package may be created by using shell elements, such as linear triangular elements (also known as S3R elements) with an element size of about less than 10 mm such as, for example, less than 5 mm, less than 4 mm, less than 3 mm, less than 2 mm, and 1.5 millimeters. Also, a material may be created by using solid elements, such as linear hexahedral elements (also known as C3D8R elements) with an element size of about 1.5 millimeters. For clarity, the mesh is not illustrated in FIGS. 3A-K, 4, and 5. Modeling a package may include the product inside the packaging material.

Many data structures are possible for representing the mesh of the package. In one embodiment, a data structure for the package includes: representing the parts by a set of nodes, and for the connected edges, classifying the edges of the polygons into connection nodes, wherein two edges that are in the same connection node have end-points on the same node.

In one embodiment, the data structure is expanded to make it more suitable for flexible packaging. The package may be represented by a stack of one or more congruent polygons with their vertices on the same locations.

The method further includes a second step 120 of simulating a deformation of the flexible form wherein the deformation is based on the interaction with another body or force and the flexible form material properties.

In an embodiment, simulating a deformation of the flexible form may represent forces upon a flexible sheet. The forces may impact the surface such that the surface may exhibit, for example, stretch points, wrinkles, bends, and other forms of deformations.

In an embodiment, simulating a deformation of the flexible form may be done by loading a package. The package may be loaded by expanding the package domain space to its full capacity and then inserting the goods within the domain space. The goods may be volumetrically compressed. Once the goods are inside the domain space, the package material may be allowed to contract onto the goods. In an embodiment, the goods are allowed to expand and are no longer compressed while the package material is simultaneously contracted to contact the goods within the domain space. The goods may be in the form of finished products, such as, for example, diapers. The goods may be deformable or non-deformable. Alternatively, loading the package may be done by adding each good to the virtual package such that the package is continuously deformed while the domain space is filled with the one or more goods.

In an embodiment, loading the package includes simulating deformation of the packing material starting from flat geometry to loaded package using finite element analysis. The simulation may include mapping one or more of the finite element outputs.

In an embodiment, a simulation starts with a flat package and a compressible diaper stack. The bag top is picked up by defined boundary condition (BC) and the stack is compressed by compression plates. Once the diaper stack is inside the bag film, the BC on the package is released and the compression plates are moved back.

The method includes a third step 130 of coupling a surface coordinate system of graphics and color position of graphic images to the flexible form wherein the color or graphic overlay utilizes the simulated position of nodes in the mesh to create a simulated appearance model.

Coupling a surface coordinate system of graphics and color position of graphic images to the flexible form may include extracting one or more frames of FEA simulation to transitive mapping software-friendly format and establish mapping between the artwork and the geometry.

Establishing mapping between the artwork and the geometry ensures that the color information on the package stretches and wrinkles accurately according to the displacements and strains in the simulated geometry. Establishing mapping between the artwork and the geometry include assigning a portion of the graphics to previously determined nodes. The graphics may be manipulated to fit the entire surface of the package or a portion of the package. The graphics may be mapped to the surface mesh such that they are stretched or strained at the same rate as the mesh. Mapping the graphics to the mesh allows the graphics to be represented under “real world” conditions while showing the impact of the good inside the package on the visual representation of the graphics.

In an embodiment, extracting each frame of FEA may include using in-house python scripts. Each frame of the FEA simulated package geometry may be extracted from their native format, and translated into a graphic rendering friendly format, such as, for example, a transitive mapping software-friendly format.

The one or more extracted frames may result in a file containing a series of individual geometries. Each geometry may represent the package shape at a different point in time.

In an embodiment wherein the simulation starts with a flat bag and a compressible diaper stack and ends with a package full with product, within the series, the starting geometry was “flat” and the final geometry was in the shape of a package filled with product. Once in a transitive mapping software-friendly format, the “flat” artwork may be mapped to the flat starting geometry via a planar projection.

UV mapping, the process that projects a texture map onto a 3D object wherein the letters “U” and “V” denote the axes of the 2D texture because “X”, “Y” and “Z” are already used to denote the axes of the 3D object in model space, or two dimensional to three dimensional mapping may be used to match parts of the artwork to the panels of the flat bag, creating an association between each pixel in the artwork image to its position on the starting geometry. Then, using a “blend shape”, a one-to-one correspondence can be established for each node in the starting geometry across nodes in all the geometry frames. Through the blend shape, a one-to-one correspondence of the artwork pixels can be transitively established across all the geometry frames, including the final one. The artwork mapped to the final geometry exhibits physically correct displacement and strain.

In an embodiment, steps 120 and 130 may be done simultaneously such that the method produces a series of frames as the flexible form is deformed wherein each frame shows the appearance of the graphics and color as the flexible form or package interacts with a force or body and/or the package is filled with a good.

The method includes a fourth step 140 of assigning visual material properties and processing a final rendering. The final rendering may be created by physics based rendering software, such as, for example, Maxwell by Next Limit. The physics based rendering software may simulate light transport using virtual lights that illuminate a virtual product as seen by a virtual camera to generate photo-real images of the package. The physics based rendering software may be integrated into the graphic rendering software, a plug-in to the graphic rendering software, or may be a separate program. Visual material properties may be assigned to process a final render.

In an embodiment, assigning visual material properties and processing a final rendering may account the impact on appearance caused by the deformations of the flexible material. The impact on appearance caused by the deformations may include, for example, changes in opacity, changes in color, change in a level of glossiness, change in a level of intensity, or combinations thereof.

Visual material properties may further account for state changes in the flexible form such as, for example, temperature, and viscous relaxation etc. State changes may affect the final rendering of the flexible form.

The final rendering is a virtual simulated 3D flexible package where all the folds and gussets are correct along with accurate artwork placement.

The method may include an optional step of manipulating the model to determine the effect of different shapes, positions, inputs, and options on the appearance of the graphics.

Manipulating the model may include entering different attributes through a user interface. The user interface provides the user with an interactive tool operative to change one or more parameters of the modeled package.

Manipulating the model may occur through the use of a user interface that allows the user to change aspects of the model, such as, for example, allowing the user to specify one or more parts of the surface where the user desires the mesh to be finer than in other parts, changing aspects of the graphics, and manipulating the package shape to simulate wrinkles or bends in the package.

Manipulating the model may include allowing the user to modify the goods inside of the package, including number of goods, the goods geometry and material mechanical behavior (compressibility etc.) Modifying the goods inside of the package may change the shape of the package and the visual representation of the graphics.

In an embodiment, manipulating the model may include determining the effect of dynamically changing forces, such as, for example, gravity. Manipulating the model to determine the effect of dynamically changing forces may include determining a stable end-state.

The method above may also be used to determine the appropriate package for a previously determined set of graphics and good(s). The model may optimize the package parameters to determine the optimum package that meets the graphic requirement set by the user for the good(s). The model may then be used to create a flexible form package with the desired graphics.

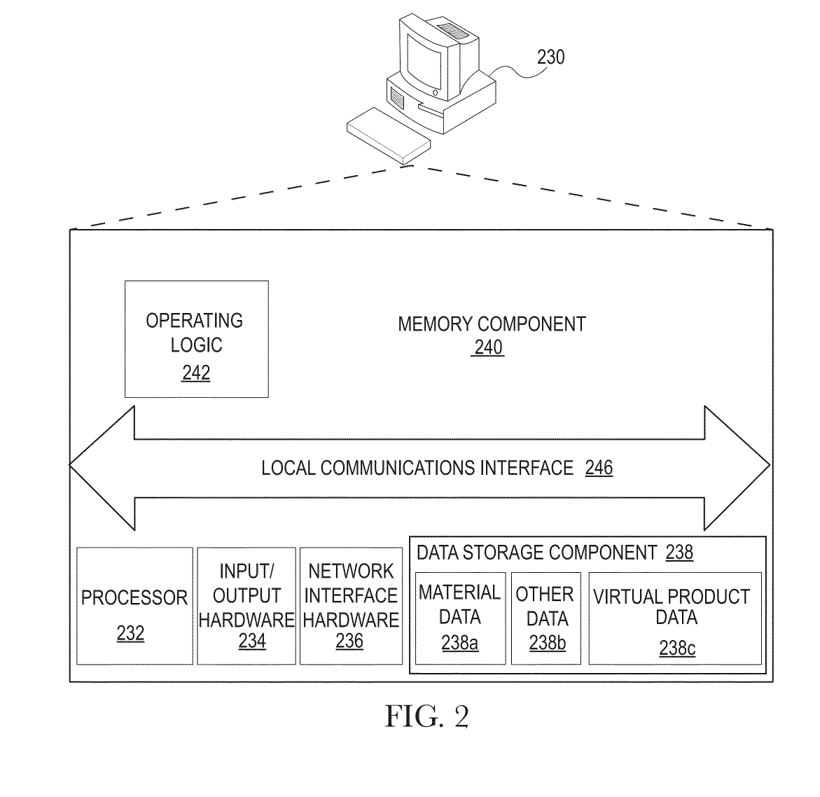

FIG. 2 depicts a computing device 230 according to systems and methods disclosed herein. The computing device 230 includes a processor 232, input/output hardware 234, network interface hardware 236, a data storage component 238 (which stores material data 238a, other data 238b, and virtual product data 238c), and a memory component 240. The computing device 230 may comprise a desktop computer, a laptop computer, a tablet computer, a mobile phone, or the like.

The memory component 240 of the computing device 230 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums.

Depending on the particular configuration, these non-transitory computer-readable mediums may reside within the computing device 230 and/or external to the computing device 230.

The memory component 240 may be configured to store operating logic 242 that may be embodied as a computer program, firmware, and/or hardware, as an example. The operating logic 242 may include an operating system, web hosting logic, and/or other software for managing components of the computing device 230. A local communications interface 246 is also included in FIG. 2 and may be implemented as a bus or other interface to facilitate communication among the components of the computing device 230.

The processor 232 may include any processing component operable to receive and execute instructions (such as from the data storage component 238 and/or memory component 240). The input/output hardware 234 may include and/or be configured to interface with a monitor, keyboard, mouse, printer, camera, microphone, speaker, and/or other device for receiving, sending, and/or presenting data. The network interface hardware 236 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 230 and other computing devices.

It should be understood that the data storage component 238 may reside local to and/or remote from the computing device 230 and may be configured to store one or more pieces of data for access by the computing device 230 and/or other components. In some systems and methods, the data storage component 238 may be located remotely from the computing device 230 and thus accessible via a network. The data storage component 238 may be a peripheral device external to the computing device 230.

It should be understood that the computing device components illustrated in FIG. 2 are merely exemplary and are not intended to limit the scope of this disclosure. While the components in FIG. 2 are illustrated as residing within the computing device 230, this is merely an example. In some systems and methods, one or more of the components may reside external to the computing device 230. The simulation, code utilized to run the simulation, or code utilized to represent any part of the simulation may be read from a computer readable media separate from the computer. It should also be understood that, while the computing device 230 in FIG. 2 is illustrated as a single system, this is merely an example. In some systems and methods, the modeling functionality is implemented separately from the prediction functionality, which may be implemented with separate hardware, software, and/or firmware.

Also included is a non-transitory computer-readable medium that stores a program that when executed by a computing device causes the computing device to receive a 3-dimensional simulation of a flexible package with graphics containing goods. Additionally, the program may further cause the computing device to determine a deformation characteristic of the product, simulate an interaction of the inner part into the outer part, measure, from the interaction, a characteristic of interaction, and determine whether the characteristic of interaction meets a predetermined threshold. In response to determining that the characteristic of interaction meets the predetermined threshold, the program may cause the computing device to send an output that indicates the first 3-dimensional simulation and the second 3-dimensional simulation are acceptable product designs. In response to determining that the characteristic of interaction does not meet the predetermined threshold, the program may iteratively alter the 3-dimensional simulation until the characteristic of interaction meets the predetermined threshold.

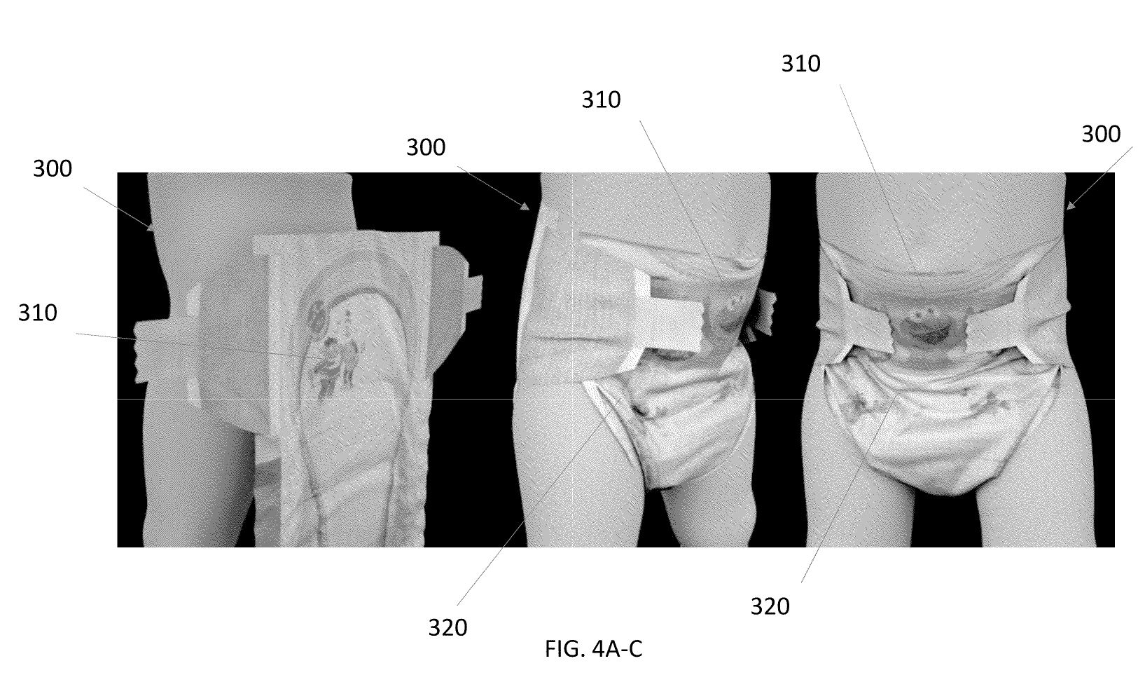

FIG. 4A-C shows perspective views of a flexible form 300 embodied as a sheet with graphics. The sheet with graphics is a diaper. As shown in FIGS. 4A-C, the method simulates the flexible form while accounting for deformations, wrinkles 320 and the effect on graphics 310.

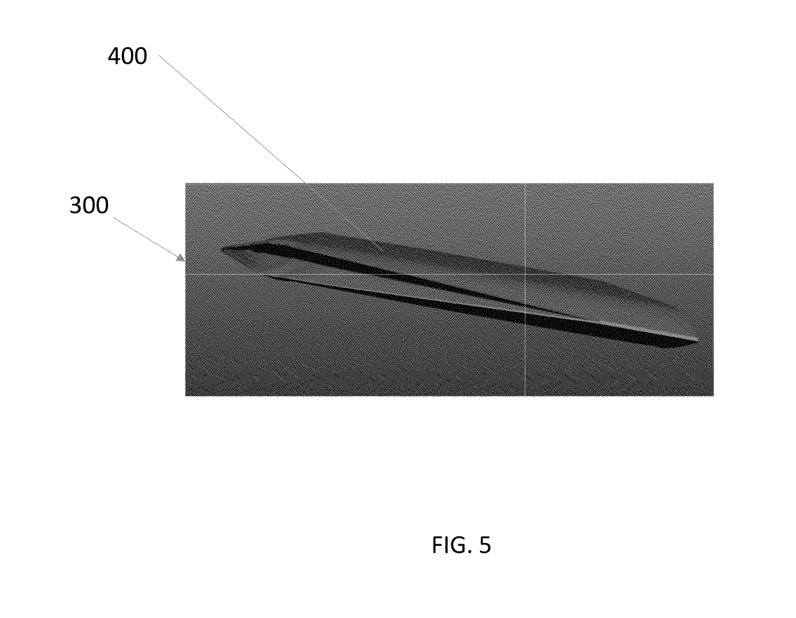

FIG. 5 shows a perspective view of a flexible form 300 embodied as a package 400 in a flat configuration. The package 400 does not have graphics.

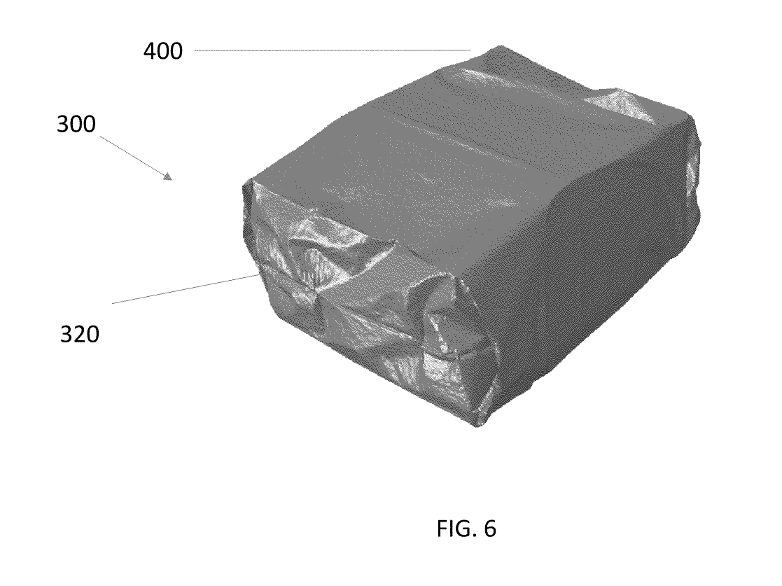

FIG. 6 shows a package 400 comprising goods without graphics. As shown in FIG. 5, the package 400 may have wrinkles 320.

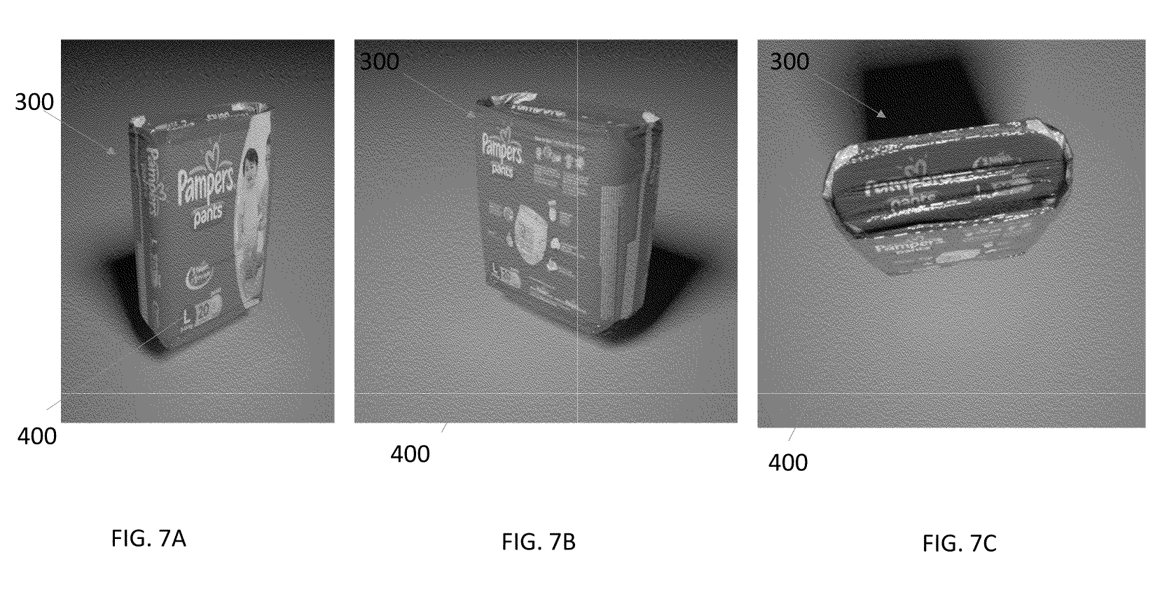

FIGS. 7A-C show perspective views of the package of FIG. 5 with graphics 310. As shown in FIGS. 7A-C, the views account for deformations of the flexible form 300 packages 400 showing wrinkles 320.

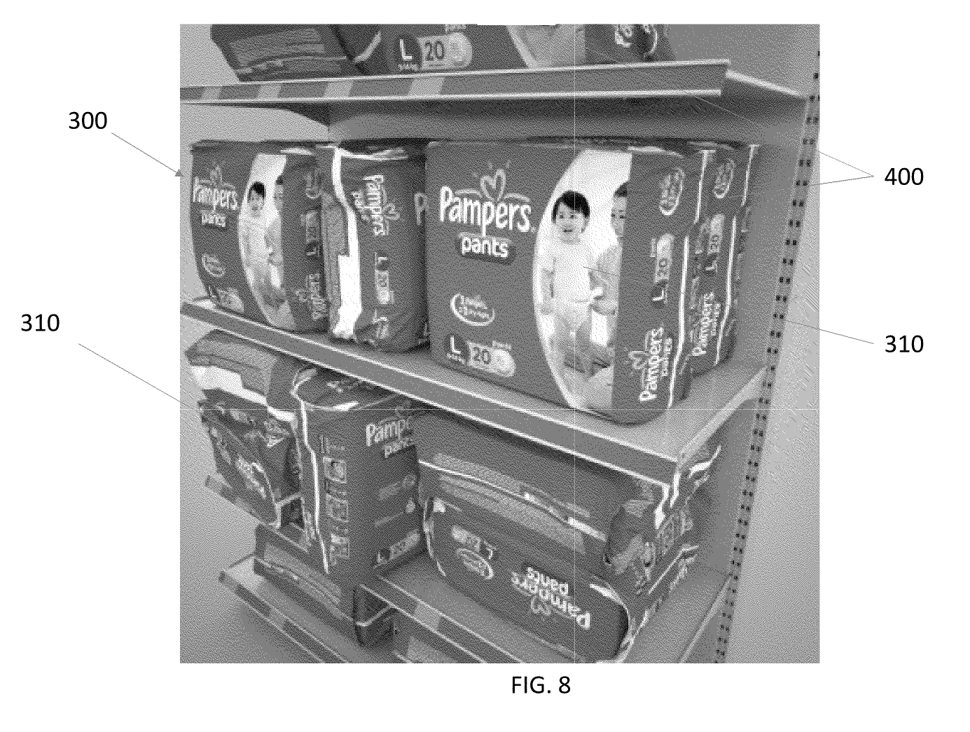

FIG. 8 shows a plurality of packages 400 with graphics 310. As shown in FIG. 7, the model may be used to show how multiple packages may be seen on a shelf.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A method for making a flexible form, comprising:
creating a computer based predictive simulation of a flexible form comprised of a mesh made of one or more nodes wherein the flexible form has a surface;
simulating a deformation of the flexible form wherein the deformation is created by interacting with a defined force, a material, a body, or combinations thereof;
coupling one or more graphics and color position of the one or more graphics to the flexible form wherein the color or one or more graphics overlay utilizes the position of nodes in the mesh to create a predictive simulation appearance model;
rendering one or more frames of the predictive simulation appearance model; and
using the computer based predictive simulation to create the flexible form with graphics.

2. The method of claim 1, wherein the final rendering comprises deformation, coupled color information, graphics, and light properties.

3. The method of claim 1, wherein the flexible form is deformed based on the force and the flexible form material properties.

4. The method of claim 1, wherein coupling one or more graphics and color position to the flexible form includes mapping a first plane to a second plane, wherein the first and second planes are tied together at one location; and wherein the first and second planes are in close proximity to each other in a second location.

5. The method of claim 1, wherein the defined force is caused by a good.

6. The method of claim 1, wherein simulating a deformation of the flexible form comprises accounting for stress and strain on the element and accounting for force and displacement on the node.

7. The method of claim 1, wherein rendering one or more frames of the predictive simulation appearance model comprises using light transport physics.

8. A method for making a flexible form, comprising:
creating a computer based predictive simulation of a flexible form comprised of a mesh made of one or more nodes wherein the flexible form has a surface wherein the flexible form is a package comprising a domain space;
simulating a deformation of the flexible form wherein the deformation is created by interacting with a defined force, a material, or a body;
coupling one or more graphics and color position of the one or more graphics to the flexible form wherein the color or one or more graphics overlay utilizes the position of nodes in the mesh to create a predictive simulation appearance model;
rendering one or more frames of the predictive simulation appearance model using light transport physics; and
using the computer based model to create the flexible form with graphics.

9. The method of claim 8, wherein simulating a deformation of the flexible form simulates placing goods inside a package using the following method:
expanding a package;
placing product inside the package such that the goods do not contact the expanded package; and
allowing the package to contract around the goods.

10. The method of claim 9, wherein the goods are compressed prior to being inserted within the package and wherein the goods are decompressed when the package contracts around the goods.

11. The method of claim 8, wherein loading the package further includes simulating deformation of the packing material starting from a flat geometry to a loaded package using finite element analysis.

12. The method of claim 8, wherein extracting one or more frames further includes applying graphics following the deformation of the packing material by exporting the simulation results to a graphic rendering softwares.

13. The method of claim 8, wherein the method further includes manipulating the model to determine the effect of different good shapes, good positions, and good inputs.

14. The method of claim 8, wherein the method further includes deforming the package due to changes in boundary conditions, wherein the changes include internal and external forces on the package.

15. The method of claim 14, wherein the internal and external forces comprise the weight of an additional package, the effect of wrapping a group of packages, increased pressure within the domain space, contracting pressure within the domain space, and combination thereof.

16. The method of claim 8, wherein the defined force is caused by a good.

17. The method of claim 8, wherein rendering one or more frames of the predictive simulation appearance model comprises using light transport physics.

18. The method of claim 8, wherein simulating a deformation of the flexible form comprises accounting for stress and strain on the element and accounting for force and displacement on the node.

19. The method of claim 8, wherein the flexible form is deformed based on the force and the flexible form material properties.

20. The method of claim 8, wherein the final rendering comprises deformation, coupled color information, graphics, and light properties.
